(19) United States
(12) Patent Application Publication
(10) Pub. No.: US 2006/0069884 A1
(43) Pub. Date: Mar. 30, 2006

(54) Universal network to device bridge chip that enables network directly attached device

(76) Inventors: Han-Gyoo Kim, Irvine, CA (US); Han-Kyu Lim, Seoul (KR)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/068,519

(22) Filed: Feb. 27, 2005

Related U.S. Application Data
(60) Provisional application No. 60/548,564, filed on Feb. 27, 2004.
(60) Provisional application No. 60/603,917, filed on Aug. 23, 2004.
(60) Provisional application No. 60/590,722, filed on Jul. 22, 2004.

(51) Int. Cl. G06F 13/00

(52) U.S. Cl. 711/154

(57) ABSTRACT

Network bridge circuit, logic, chip, and method that enables a host computer to access a storage device or a plurality of storage devices directly from the network. Hardware architecture includes protocol layer handler, DMA, storage device interface, command execution unit, and optional error handler. Bridge circuit logic implemented on a single chip in hard wired fashion without resorting to a programmable architecture. Generic command wrapper in which new commands added later time than the time of fabrication of the hardware chip can be executed without revising the hardware chip. Bridge apparatus enabling direct access by at least one host to a raw storage device over network, comprising: command execution unit, memory controller, network interface, device interface controller, and wherein bridge apparatus couples the raw storage device to network directly such that host accesses raw storage device as if local storage device even though only available over network.

### RELATED APPLICATIONS

This patent application claims the benefit of priority under 35 U.S.C. §119 and/or 35 U.S.C. §120 to U.S. Provisional Patent Application Ser. No. 60/548,564 filed 27 Feb. 2004 entitled Universal Network To Device Bridge Chip That Enables Network Directly Attached Device, and which is hereby incorporated by reference.

U.S. patent application Ser. No. 09/974,082, entitled “Disk System Adapted to Be Directly Attached to Network” filed Oct. 9, 2001; U.S. Provisional Patent Application Ser. No. 60/603,917, entitled “A Network Direct Attached Storage Suitable for Home Network,” filed Aug. 23, 2004; U.S. Non-provisional patent application Ser. No. 10/195,817, entitled “Scheme for Dynamically Connecting I/O Devices Through Network” and filed on Jul. 15, 2002; U.S. Provisional Application Ser. No. 60/590,722, entitled “Low Level Communication Layers and Device Employing Same” and filed on Jul. 22, 2004; and U.S. Provisional Application Ser. No. 60/590,722, entitled “A Network Direct Attached Storage Suitable For Home Network” and filed on Aug. 23, 2004; all of which are related applications are hereby incorporated by reference as if fully set forth herein.

### FIELD OF THE INVENTION

This invention relates generally to apparatus, device and method for interfacing or bridging a raw device and a network, more particularly to a bridge chip device and method for bridging a raw data storage device and a network, and even more particularly to a Gigabit Ethernet network to ATA/ATAPI storage device bridge chip and bridging method that enables a raw ATA/ATAPI disk drive data storage device to be directly attached to the Gigabit Ethernet network and to operate as a high performance network-directly attached storage device.

### BACKGROUND

Storage devices and storage capacity of such devices has become one of the most important components in consumer electronics and home network based storage because of the introduction of many digital media or multimedia electronics, such as high definition television or TV, Personal Video Recorder (PVR), digital cameras, digital video camcorders, digital audio players, and set-top boxes or systems, and long-term archival digital storage. Each of these separately and certainly in combination generates an increasing need for high volume multimedia data storage.

In spite of the important and increasing need for home networked storage devices to provide storage capable of handing all of the consumer electronic and media storage needs in the home, there has heretofore been little recognition of the need for or of suitable architectures and devices for home networked based storage. Although retail electronics stores are selling increased numbers and capacities of storage devices, these conventional storage devices and systems, such as for example network file servers and external hard disk drives with universal serial bus (USB), IEEE 1394 (Firewire), or other relatively fast and contemporary interfaces do not satisfy the new generation of requirements for the storage devices for home networks.

Characteristics of home network storage devices should advantageously include: (i) cost effective storage, (ii) easy storage management, (iii) convenient sharing, (iv) high performance, and (v) unlimited expandability. Therefore, there remains a need for cost effective storage where the storage device, interfaces, and any removable media should be inexpensive in order to accommodate the huge amount of multimedia data at low cost and affordable by the home or residential consumer. The home network storage should be easy to use, add onto, manage and maintain without requiring an information technology, computer science, or other technical background. There remains a need for convenient sharing of multimedia data and/or other data by multiple hosts over the network. Such hosts may be computers, information appliances, audio players and/or recorders, video players and/or recorders, digital cameras, and the like.

There also remains a need for networked storage that has comparatively high performance so that the huge volume of multimedia data can be transferred or transmitted for efficient usage of the data. For example here may in some situations be a need for real-time or substantially real time retrieval from storage so that a high-definition television movie may be played over the home network at the same time some other data, media, or content is being retrieved from or stored to the networked storage device or storage system.

Finally, there remains a need for a storage system and method where storage capacity may be added to incrementally as additional storage capacity is needed or desired, and also advantageous that the earlier storage remain useful and utilized even when new and additional storage is added.

Traditional storage devices and storage methods including the network attached storage (NAS) type and external disk drives coupled to a computer by a cable connection (such as Universal Serial Bus USB or IEEE 1394 hard disk storage drives) fail to meet the needs of home networked storage for several reasons.

External hard disk drives or other rotating media or solid state memory with USB or IEEE1394 interfaces simply do not provide networking facility between and among a plurality of devices that would need to store data to or retrieve data from the storage device, and therefore fail to provide the desired level of data, media, or content sharing on or over a network.

With respect to network attached storage (NAS), it may be appreciated that it is practically difficult to achieve the required performance for all the entertainment devices such as television and other image or video based media and digital audio systems with NAS server based storage because the NAS client software that would be required on each of the entertainment devices requires significant amount of complex software and resources. Moreover, NAS servers may usually fail to provide scalable data services, and may become single point of failure or performance bottlenecks because all the data coming from or going to the NAS storage device have to go through the memory of the NAS servers. Scaleable data services are generally data services that preserve the same response time to the service requests regardless of the increased number of requests by providing resources proportionally. There is a limit to the amount of memory that a home network user would be willing to purchase or be able to install within a low to mid range server computer. Besides their intrinsic limitation in scalability and expandability of the storage space, it is in practical terms, difficult to build cost effective NAS servers with reasonably high performance because NAS servers are built on top of complicated network file system which require quite significant amounts of memory and a powerful CPU or processor. For example, a typical NAS server requires a network file system, a processor or CPU running at a speed of at least tens of MHz (and typically much higher speeds), and at least hundreds of Mbytes of RAM coupled to the processor. Even a lower end or minimum NAS server would preferably provide a network file system, a processor or CPU running at a speed of at least tens of MHz, and at least several Mbytes of RAM coupled to the processor.

### SUMMARY

The present invention devises a cost effective high performance network bridge circuit, logic, chip, and method that enables the host to attach a storage device or a plurality of storage devices directly to the network.

In accordance with one aspect of the invention, a hardware or hard wired logic bridge chip architecture is provided that includes a protocol layer handler, a DMA, a storage device interface, a command execution unit, and an optional error handler. In one aspect, the bridge circuit logic is deigned to be implemented on a single chip in hard wired fashion without resorting to a programmable architecture, such as to a CPU-DRAM architecture.

In another aspect, the invention facilitated by a generic command wrapper in which new commands added later time than the time of fabrication of the hardware chip can be executed without revising the hardware chip.

In another aspect, the invention provides a bridge apparatus enabling direct access by at least one host to a raw storage device over a network, the bridge apparatus comprising: a command execution unit for executing command packets received from the at least one host; a memory controller coupled to the command execution unit; a network interface including a network interface protocol layer handler for coupling the network with the command execution unit; a device interface controller coupling the command execution unit with the raw storage device; and wherein the bridge apparatus couples the raw storage device to the network directly such that the host accesses the raw storage device as if the raw storage device is local storage device even though the raw storage device is only available over the network.

In another aspect the invention provides a method for bridging a device, such as a raw storage device, to a host over a network.

### BRIEF DESCRIPTION OF THE DRAWINGS

The features of this invention will be best understood from the following detailed drawings:

FIG. 1 is an illustration depicting an embodiment of a typical home network where a network directly attached storage device is attached and shared by multiple hosts over the network.

FIG. 2 is an illustration depicting an embodiment of a block diagram of the bridge chip of the present invention.

FIG. 3 is an illustration depicting an embodiment of a block diagram of the protocol layer handler of the present invention.

FIG. 4A is an illustration depicting an embodiment of a Content Addressable Memory (CAM) address look up.

FIG. 4B is an illustration depicting an embodiment of the tagging mechanism of connection management of the present invention.

FIG. 5 is an illustration depicting an embodiment of the block diagram of the command execution unit of the present invention.

FIG. 6 is an illustration depicting an embodiment of the command format mechanism of the present invention.

FIG. 7A is an illustration depicting an embodiment of the two clock tree design of a typical MAC.

FIG. 7B is an illustration depicting an embodiment of an exemplary reduced clock tree design of the present invention.

FIG. 7C is an illustration showing a timing diagram for the transmitted data when the reduced clock tree technique of FIG. 7B is utilized.

### DETAILED DESCRIPTION OF THE EMBODIMENTS

The present invention provides an architectural, functional, and circuit design for a bridge chip that enables the recognition and realization of new storage devices that satisfy the desired characteristics of the storage devices for home network as well as other networks.

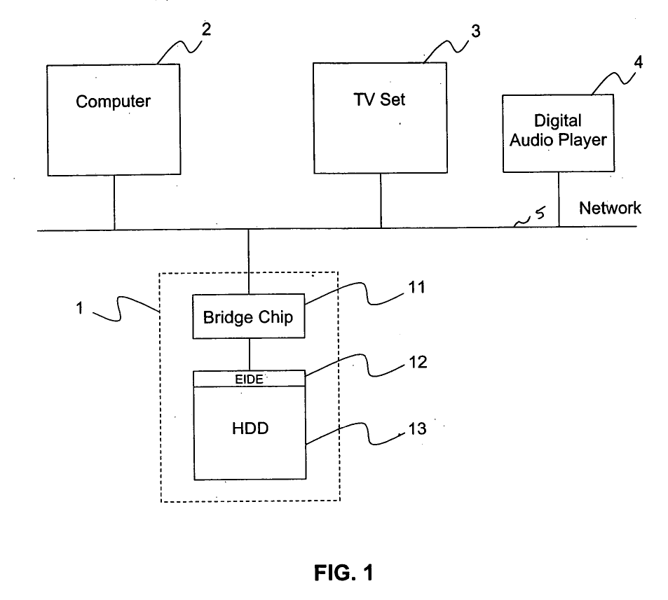

FIG. 1 is an illustration showing a typical home network having and using what may be referred to as “raw”, “virgin”, or other conventional storage devices that are directly attached to the network via the bridge chip of the present invention. The raw or conventional storage devices themselves may usually provide non-volatile persistent storage and may be of any type, such as but not limited to rotating magnetic media hard disk drive storage devices, rotating optical media drives such as CD, DVD, ODD, or other optical disks, solid state or other semiconductor memory, or any other type of storage or memory. In one embodiment, a raw or virgin hard disk drive type storage device may for example be a conventional ATA, ATAPI, EIDE, SCSI, USB, Fire wire or other interface hard disk drive may by companies such as Seagate, IBM, Hitachi, Western Digital, or other manufacture.

In the particular embodiment described immediately below, the storage device is an ATA/ATAPI hard disk drive coupled through an EIDE interface. This is merely exemplary and storage devices other than ATA, ATAPI, or ATA/ATAPI may instead be utilized; and, interfaces other than EIDE may alternatively be used as well. Bridge apparatus 11 may be in the form of an electronic logic circuit formed as a solid state chip on a single substrate. This chip may be provided as a separate electronic device, integrated with or mounted to the raw storage device, or incorporated into an interface between the network connection and the raw storage device. It may also be appreciated that conventional raw storage devices may be modified to include the network-to-device bridge circuit. Bridge apparatus 11 provides an interface capability between the network and the raw device and thereby effectively converts the raw non-networked storage device into a networked directly attached storage device.

With further reference to the FIG. 1 embodiment, bridge chip 11 of the present invention is connected to an ATA/ATAPI hard disk drive 13 through EIDE interface 12. Embodiments of various configurations of ATA/ATAPI hard disk drives and EIDE interfaces configured as network attached disks (NAD), NetDisk®-type or NDAS®-type network directly attached storage device made by XiMeta, Inc in Irvine, Calif. are described in the co-pending related applications section of this specification.

Other variations of storage devices and disk drives that incorporate various interface circuits and/or capabilities are network attached disk (NAD) or non-disk network attached storage devices, and NDAS®-type network directly attached storage devices or NetDisk®-type network directly attached storage device (made by XiMeta, Inc. of Irvine, Calif.).

These network attached disks (NAD), other network attached storage devices that may or may not be disk-type or Hard Disk Drive (HDD) type drive storage devices, and more especially NDAS® and NetDisk®-type network attached disks or storage devices that are directly attached to the network and can be accessible to the computer or other host as a source or receiver of data or content. It is noted that NDAS® and NetDisk® are registered trademarks of XiMeta, Inc., 15251 Alton Parkway, Irvine, Calif. 92618. Attributes of selected embodiments of NAD, NDAS®-type, NetDisk®-type directly attached passive network storage devices are described in co-pending U.S. patent application Ser. No. 09/974,082 filed 09 Oct. 2001 entitled Disk System Adapted To Be Directly Attached To Network, and herein incorporated by reference in its entirety. Although such network-attached disk (NAD) or NetDisk®-type directly attached network storage devices such as hard disk drives are well adapted to be used with and to cooperate with features of the instant invention, the instant invention is not limited to operate only with such NAD or NetDisk®-type directly attached network storage devices.

As described in U.S. patent application Ser. No. 09/974,082, an embodiment of network-attached disk (NAD) system includes an NAD device for receiving a disk or other storage device access command (or data) from a computer, host, or other device or system over a network, and a device driver in or at the player for controlling the NAD device through the network, where the device driver may create a virtual host or player bus adapter so that the player recognizes the NAD device as if it is a local device to the player. The NAD device itself may include a disk or other storage means for storing data, a disk or other storage media controller for controlling the disk or other storage media, and a network adapter for receiving a disk or other storage device access commands through a network port.

The network attached storage device 1 of the present invention comprises any storage device, system, or medium 13 that is directly attached to the network 5 through a storage device interface 12, and the inventive bridge unit 11. The network attached storage device, may be or is shared by multiple hosts such as for example, including a computer 2, a TV set 3, and a digital audio player 4 over the network. By directly attached we mean generally that the passive raw device (such as HDD 13 alone or with its EIDE interface 12) is attached to the network through the interface or bridge chip or circuit 11 of this invention without entailing a processor or CPU, random access memory such as a DRAM, and operating system software between the interface or bridge chip of this invention and the device.

The device may be shared in a manner that the device services or may service multiple hosts at the same session by sending and receiving the data to and from the multiple hosts in a concurrent, simultaneous, or time-sharing manner.

The bridge chip and circuit 11 of the present invention comprises a hardware interface chip and the circuits and optional software and/or firmware that enables various types of storage devices to be transformed into network directly attached storage devices (such as NDA, NDAS® or NetDisk® aspects of which are described in the related applications). That is, the devices that are attached directly to the network yet may advantageously be recognized as local devices to the hosts (of virtually unlimited type) over the network. Aspects of the bridge chip 11 functionality and circuitry are described as are methods implemented by the bridge chip alone and in cooperation with the network and storage device.

It may now be appreciated that at least two of the problems and limitations of conventional systems and methods are solved by using the directly attached network storage devices in the manner described herein. First, the single point of failure and performance bottleneck associated with memory of conventional NAS servers is eliminated because unlike conventional NAS all the data coming from or going to the directly attached network storage device does not have to go through the memory of any server. It will be appreciated that an NAS server, as well as other servers, has memory (typically DRAM) connected through its memory bus. All the data in NAS server has to go through the memory before the data is stored to or retrieved from the hard disk drive (HDD) or other mass storage device. So, when the multiple HDDs or other storage devices are installed in a NAS server, the memory data path becomes the performance bottleneck and it also becomes the single point of failure because all the data has to get through the same data path.

The inventive system, bridge device, and method of bridging also provide scaleable data services because one may simply add additional directly attached network storage devices and they essentially add in parallel, each added storage device providing both additional storage capacity and whatever data path is required to support that storage, and a measure of control in a linear manner. Whereas, in conventional NAS server where multiple HDDs (or other storage devices) are sharing the same internal memory data path, there cannot be performance scalability because all the data has to go through the same single physical data path that includes the server memory. However, in an NDA or NDAS approach, each individual HDD or other storage device has its own independent data path, such as for example an Ethernet link, without sharing the bandwidth with other NDAS HDDs. As a further comparison, in order to achieve the scalability using NAS servers, one would have to use as many NAS servers as the number of individual HDDs. That is, one would need multiple NAS servers where each NAS server has to have only one HDD in it. This type of configuration would be sub-optimal at least because of the cost of the server, the server side software, and operating system that are required for an NAS configuration that are not required for a NAD configuration.

The inventive system method, and device are also much simple and lower cost because unlike NAS servers that are built on top of complicated network file system which require quite significant amounts of memory and a powerful CPU or processor, the inventive device, system, and method only require a simple chip that in some embodiments is entirely hard-wired hardware, and in other embodiments may provide hardware with some software or firmware upgradability. There is no need for a separate file system, significant memory, or powerful CPU or processor because the host system simply sends the disk read/write commands over the network as if the host sends the commands to its own internal HDD or other internal storage device. In a conventional NAS configuration, the host sends file access requests (instead of read/write device commands) to the NAS server that is a stand alone autonomous system, meaning that the NAS server has to install CPU, DRAM, and operating system. These features and advantages of the invention will become increasingly apparent once additional details of embodiments of the invention set forth hereinafter are understood and appreciated.

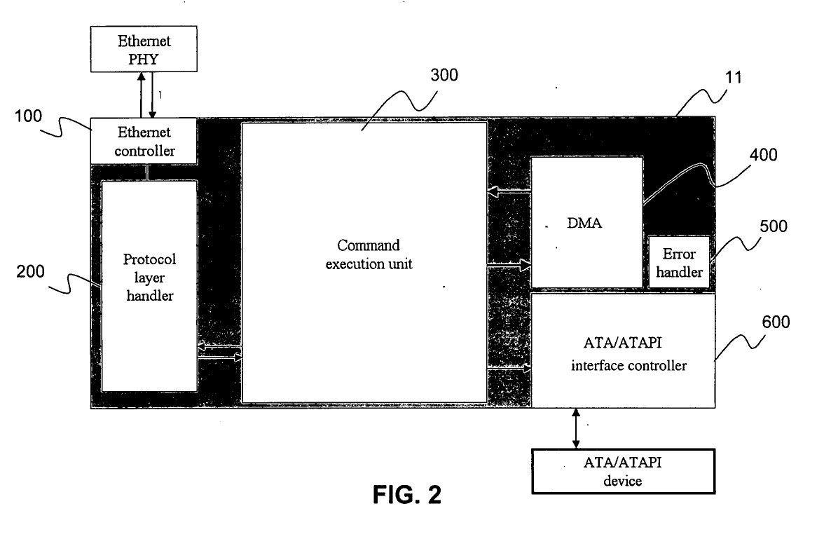

FIG. 2 is an illustration showing an exemplary embodiment of a bridge chip 11 of the present invention. It may be appreciated that although it is referred to as a bridge chip, the functionality of the chip may be included in another chip or chip set that has additional duties, such as for example as circuitry on a hard disk drive controller card or chip or within a chip or plurality of chips, within a network interface chip of circuit, within a cable, or anywhere else in the data path between the raw storage device and the network connection. It may also be appreciated that the functionality and/or circuits of the bridge functional block 11 may be distributed over multiple physical chips, though this later approach is not preferred.

In the illustrated embodiment, bridge block 11 is composed of Ethernet controller if the network is an Ethernet network (or other network controller appropriate to different network types) 100, a network protocol handler 200, a command execution unit 300, a direct memory access (DMA) controller 400, an error controller 500, and an ATA/ATAPI interface controller (or other appropriate storage device interface controller) 600.

The Ethernet or other network controller 100 receives and transmits command packets and reply packets over the network. When the network controller is an Ethernet controller and the selected communication protocol is a NDAS® communication protocol, the network controller receives and transmits command packets and reply packets over the network as specified in the NDAS® communication protocol through Ethernet PHY chip. Networks other than Ethernet networks may alternatively be used. Embodiments of the invention that only receive or only transmit may be envisioned but they are not the most interesting configurations.

The selected communication protocol, such as a selected NDAS® communication protocol, is a protocol that governs the data transfer between the host system and the device that is attached directly to the network through the interface chip of this invention.

The network physical layer, such as an Ethernet PHY or Ethernet physical layer chip or logic, is responsible for interfacing the network frame (such as an Ethernet network frame) to the actual physical data link, such as the actual physical data link of Ethernet. Any network typically needs a physical interface at the last end. This last end or actual end that interfaces to the physical medium of the network is usually referred to as a physical or PHY. A PHY is usually implemented as a form of small chip that interfaces the network protocol processing core to the actual network cable. Ethernet PHY is described in greater detail in “Ethernet: the definitive guide” by Charles E. Spurgeon, O'reilly book publishing, which is hereby incorporated by reference.

The network protocol layer handler 200 processes packets received from the Ethernet controller 100, before transferring the processed packets to the command execution unit 300. The packets from the command execution unit 300 are transmitted after being processed by the protocol layer handler 200. The DMA controller 400 handles direct memory access operation between the storage device and the bridge chip. The optional error controller 500 handles some error situations that may occur. In one embodiment, all the ATA/ATAPI commands and data to and from the ATA/ATAPI storage device connected to the bridge chip of the present invention are processed through the ATA/ATAPI interface controller 600. Notice that ATA/ATAPI interface controller may be replaced by other types of device interface such as SCSI, serial ATAPI, or other storage device interface, thus accommodating various types of storage devices and not limiting the invention only to ATA/ATAPI devices.

### Embodiment of the Network Protocol Layer Handler

In one aspect, the invention provides a functional and physical design of a bridge chip for realizing network attached storage devices, including but not limited to a particular NDAS®-type storage devices such that the communication protocol (such as a NDAS® communication protocol) to/from such storage devices is processed completely or substantially hardware or hard-wired fashion, or with a minimum of firmware and/or software in conjunction with the hardware, by the bridge chip 11. In at least one embodiment, a bridge chip is realized and implemented on a single CMOS chip without resorting to an extra software and/or firmware programmable processor or ASIC.

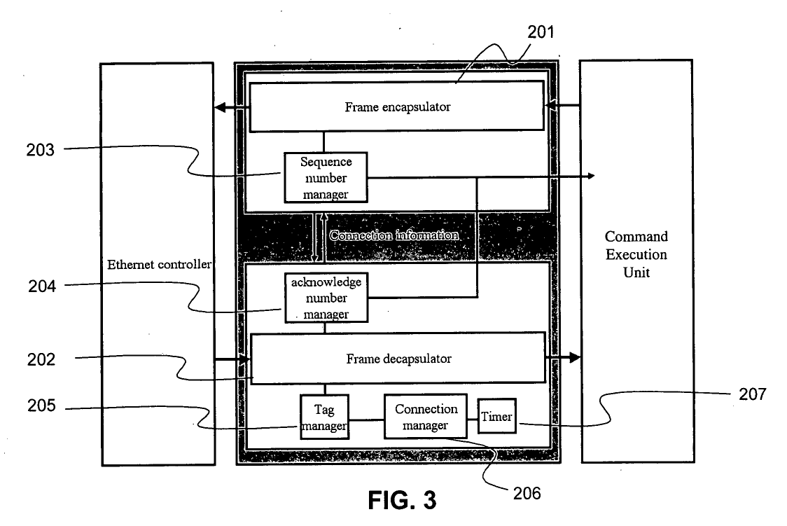

FIG. 3 is an illustration showing an exemplary embodiment of the protocol layer handler in a block diagram form and includes a frame encapsulator 201, a frame decapsulator 202, a packet sequence number manager 203, and an acknowledge number manager 204. A frame generally means or includes a sequence of serial bits specified for a data link protocol, such as Ethernet. There is a need to extract or remove (i) pre-frame information that is irrelevant to the commands, and (ii) commands and (iii) data (if any) from the frames received before processing the commands and the data. There is an analogous but different need to encapsulate (meaning to add head and tail or leading and trailing bits a frame to make the final sequence of bits of the correct form of the frame) the data before the frame may b sent.

The frame encapsulator 201 encapsulates the packets that are to be sent from the combination of the raw storage device (possibly including a storage device interface) plus the bridge apparatus forming the network attached storage device to the host by adding a header according to a predetermined header protocol. In one embodiment, the predetermined header protocol is a NDAS® protocol. Embodiments of a NDAS® protocol are described in U.S. Provisional Patent Application Ser. No. 60/590,722, filed 22 Jul. 2004 and entitled “Low Level Communication Layers and Device Employing Same”; which is hereby incorporated by reference.

The frame decapsulator 202 extracts information necessary to process the data transfer commands from the frames received through the Ethernet controller and transfers the results to the command execution unit 300 for further processing of the commands. In one embodiment, the necessary information may include some or all of the following information types: data transfer command types such as read or write, control command types such as login or logout, data transfer size, and a timestamp. Some of these may for example be information necessary for transferring the data to and from the network attached storage, such as a NDAS®-type storage or NetDisk®-type storage as well as other information items used for control.

The packet sequence number manager 203 and acknowledge number manager 204 detect any packet loss by comparing the order of the sequence number of the packets received by the network attached storage device or system and of the packets to be sent by the network attached storage. All the connection oriented (i.e., reliable) network protocols may advantageously have a numbering mechanism to identify each packet transferred and acknowledges the receipt of each packet by replying back the sequence number.

The protocol layer handler may manage multiple connections with multiple numbers of hosts simultaneously by means of tags and tagging. Recall, that embodiments of the invention advantageously provide for any one (or more) network attached storage devices formed from a raw storage device (optionally with its own interface) and the bridge circuit 11, such as NDAS®-type network attached storage devices or NetDisk®-type network attached storage devices, to be shared by multiple hosts. Each host and the network attached storage maintain the network connection respectively. The way a network directly attached storage device maintains the multiple connections with multiple hosts is to keep record of the information on those connections. In networking jargon, a connection is sometimes called ‘socket pair’ because a connection is by definition (information to identify the one end, information to identify the other end) and the term ‘socket’ is used to represent the information for that purpose. In usual cases, the information as to identify (for example, the socket) is a network address of one end and the port number of the end that uses the specific connection. The port number is a logical number to identify the service path that uses specific network connection.

The tag manager 205 manipulates the tag field of the inventive bridged network attached storage protocol packets. When protocol layer handler 200 receives a connection establish request packet from a host that wants to establish a connection with the network attached storage device for data access, the tag manager 205 stores the source address and port number of the host making the connection establish request and assigns a tag number to the connection. The tag number is acknowledged by the network attached storage to the host as stamped, marked, flagged, or otherwise indicated in the tag field of the reply packet sent to the host at the exchange to the connection establish request packet. After the connection is created, the tag manager 205 checks to determine if all the packets received by the network attached storage (received packets) are originated from the proper host by comparing the source address and port number of the packets to the connection information saved by the tag manager 205. The host is proper or legitimate if the tag number matches and the host is improper or not legitimate if it does not match.

Although aspects of the invention may be implemented without the inventive tagging methodology, or without using any tagging, advantageously the tagging mechanism of the present invention simplifies address look-up procedure required for host and storage device connection management. It is advantageous to have an effective and efficient means of fast look-up to handle packets, especially packets transmitting at line speed of 1 Gb/s or higher (typical of current networks and network speed expectations) because ineffective and slow look-up may likely prevent fast processing of the incoming and outgoing packets at line speed. Of course the invention is not limited to networks where the packets transmit only at a line speed of 1 Gb/s or greater. For example, the packets may transmit at a line speed of substantially 100 Mb/s or greater, or at any line speed of between substantially 100 Mb/s and 100 Gb/s.

When the inventive tagging is not utilized, content addressable memory (CAM) may be implemented for the address look-up hardware and method.

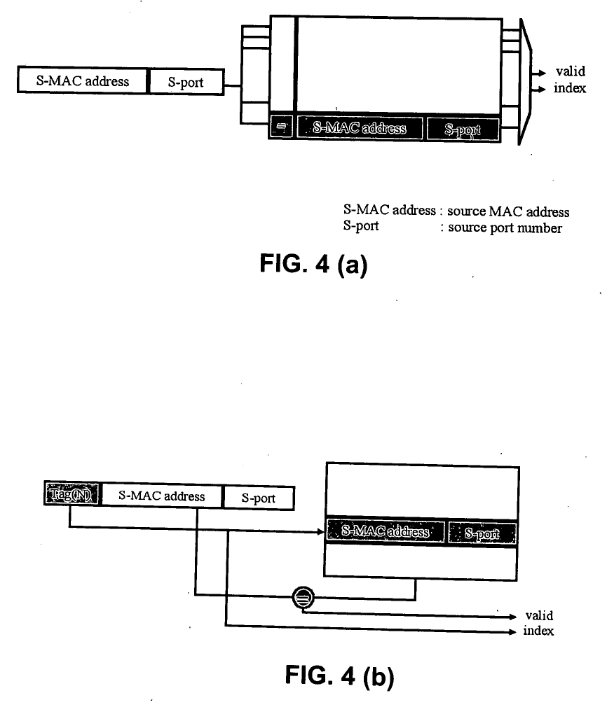

As illustrated relative to FIG. 4A, the CAM may produce a result in one machine clock cycle since it has comparators at all the memory cells. However, CAM occupies larger chip area and consumes more power than for example static random access memory (SRAM).

FIG. 4B illustrates and embodiment of an implementation of the address look-up hardware of the present invention. The address look-up hardware of the present invention uses only one comparator and SRAM instead of using CAM by exploiting the tagging mechanism of the present invention described elsewhere herein, yielding a design that operates fast and occupies smaller chip area consuming less power.

The connection manager 206 triggered by periodic timer 207 in FIG. 3 clears up or fixes any connection that disconnected abnormally during the process of data transmission.

### Exemplary Embodiment of a Command Execution Unit

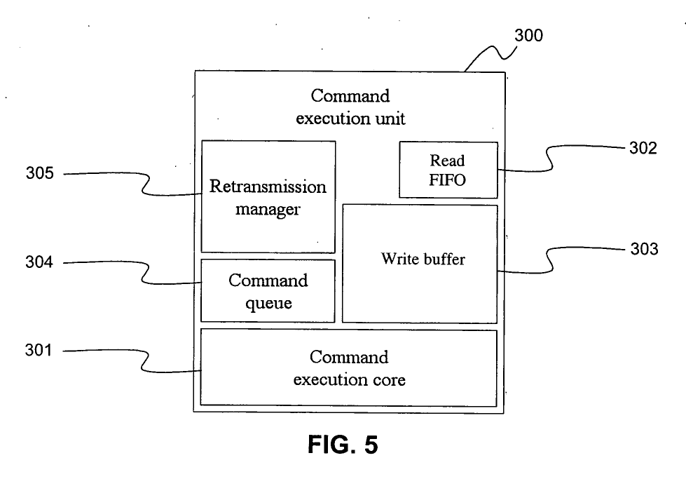

The command execution unit 300 of the present invention processes command packets from the hosts. In FIG. 5 is an illustration in block diagram form showing an embodiment of the command execution unit composed of command execution core 301, a read first-in-first-out (FIFO) buffer or data structure 302, a write buffer or data structure 303, a command queue 304, and a retransmission manager 305. All the commands may be stored in order by the protocol layer handler into the command queue 304. The command execution core 301 parses the commands in the queue, and controls the write buffer 303 as well as the storage device interface controller (which in one embodiment may be an ATA/ATAPI interface controller for an ATA/ATAPI storage device. The command execution core that controls the write buffer is designed to immediately write data to the storage device. However, when the ATA/ATAPI interface controller is busy processing other commands the data to be written are queued in the write buffer 303 before being stored to the storage device. Parsing of the commands in the queue includes the steps of command type identification, data transfer size identification, and possibly others. Note that the word parse or parsing is generally used to mean generic processing of given commands. One command may usually include many parameters, thus requires identification of the actual action lists according to the commands with specific parameters before execution of the action. Parsing means such information processing process and possible identification and extraction of parameter, before action execution. Any command that fails to be parsed or does not appear to make sense after being parsed, should be discarded—this is one good way preventing ill-purposed or malicious commands given or created by faults or computer virus.

The command execution unit 301 also controls the read FIFO 302 where data to be read by the hosts are temporarily stored for possible retransmission. Recall that retransmission may be required (or desired) when there is no acknowledge of the receipt of the packet before timeout. Retransmission is required for reliable data transfer and may occur when the one end that sent the specific packet fails to receive the acknowledge (ack) from the other end that are the addressee of that specific packet within a preset time interval, i.e., timeout. If the original sender does not receive the acknowledge on that packet, it is believed that the original packet is lost in the middle, therefore retransmission is desired.

In connection-oriented protocol in general, all of transmitted data are held for retransmission until all the corresponding acknowledgements are received. In the present invention, the retransmission manager 304 holds only the most recently processed command instead of all the data transmitted. When a packet is lost, retransmission manager puts the most recently processed command held into the command queue 304 again and rolls back the sequence number so that the command can be processed again. A determination may be made that a packet is lost when an acknowledgement on the packet we just sent has not been received and timeout period expires. At that time, one may safely determine that the packet that was just sent is lost. If the packet actually has been sent to the other end, retransmission does not hurt because the other end knows the packet is a retransmission by looking at the sequence number of the retransmitted packet. If the packet received has the same sequence number received before, then the receiver knows it is the retransmission. This re-processing of the command results in the retransmission of the reply data when the data sent are lost.

### Exemplary Embodiment of the Generic Command Format

With further reference to FIG. 5, the embodiment of the command execution core 301 may support any new commands added later time than the time of fabrication of the chip without requiring an update or revision to the hardware chip. In one embodiment, there is a requirement that the new command should fit within the maximum size of the command packet defined, but in general this maximum size may be chosen during the design of the chip. Recall that embodiments of the invention are entirely hardware or hardwired and do not have software or firmware updateable or programmable elements and so an ability to add support for other or different commands or other capabilities is advantageous to prolonging the lifetime of a device and maintaining its usability. (Other embodiments may provide for some firmware and/or software programmability and would be updateable as well either via the generic command format and/or via the software and/or firmware reprogramming.)

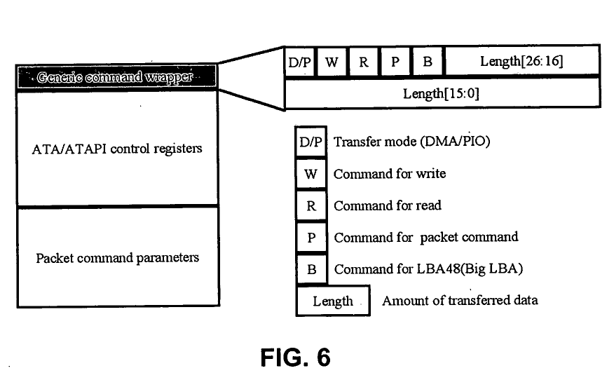

To realize this upgrade path, an inventive generic command format is provided and may optionally be used with the bridge chip and bridging method. One embodiment is illustrated in FIG. 6. A generic command wrapper located within the frame, and in one embodiment located at the start or head of frame, dictates or specifies how the command execution core operates. In general terms, the generic command wrapper dictates or specifies how the command execution core operates.

One purpose of the generic command wrapper of the invention is to reduce the chip implementation burden. It is know that to properly process the commands, one needs to parse the commands meaning reading all the parameters in the commands and look up the action list table—these kind of look-up table implementation may typically be costly in a hardware chip. By pre-sorting the types of commands using bit fields by the host system before the host system actually send the commands, the chip can reduce the burden of look-up table and others. All the commands fall into one of several categories, where each category of the commands uses the same logic in the chip for the execution of the command. The commands in the same category requires the same execution engine, but may use different set of parameters. Therefore, the idea of generic commands wrapper in this invention saves logic in the implementation of the invention.

In one embodiment using ATAPI storage devices, instead of sending the ATAPI commands as is, the host system presorts the ATAPI commands into one of the five (or six depending on the view-point) categories of the ATAPI commands and wraps the commands according to a scheme analogous to the scheme illustrated in FIG. 6. The chip can then save time in parsing because the host sent the commands with additional information. Another good feature of this wrapper is that one can send new ATAPI commands that were not defined a priori as long as the new ATAPI commands fall into one of the existing categories. This feature is advantageous because it is not uncommon to witness the individual OEM or other vendors extending ATAPI commands (or other commands) of their own at later time.

When the storage device is an ATA/ATAPI type storage device and the commands associated with the ATA/ATAPI type storage device are ATA/ATAPI commands, the ATA/ATAPI commands may be classified into two command groups: (i) disk commands for ATA devices, and (ii) packet commands for ATAPI devices. Therefore they may generally have different command formats and contents. The packet commands for ATAPI devices may usually be the same as disk command for ATA devices, except for writing additional packet command parameters.

Each of these two top-level ATA/ATAPI command groups may, in turn, be divided into several lower commands groups or subgroups at a finer level of detail and may for example include: (a) non-data, (b) PIO data-in, (c) PIO data-out, (d) DMA read, and (e) DMA write. The non-data command may be used to set some parameters without data transfer. The PIO data-in and PIO data-out commands may be used to read or write data in PIO mode. The DMA read and the DMA write commands may be used to read or write data in DMA mode. Packet commands are the same as disk command except writing additional packet command parameters.

The inventive command execution core 301 may operate without parsing the value of control registers and packet command parameters. The command execution core 301 may simply decode the bit flags of the generic command wrapper, and transform the commands into the corresponding ATA/ATAPI commands. This feature enables it to accommodate all kind of commands that were not present or identified at the time the bridge chip was designed or fabricated, but can be added at the later time without revising the hardware. Furthermore, the inventive generic command format may also simplify the fabrication of the hardware of command execution core 301. Without generic command format, command execution core 301 may otherwise need to have a large command table for the parsing of the control registers and the packet command parameters for ever possible command it may encounter.

In one embodiment, the command execution core 301 operates without parsing the values of control registers and packet command parameters by decoding at least one bit flag (and possibly a plurality of bit flags) of the command wrapper, and transforming the commands into the corresponding ATA/ATAPI commands (or other set of commands). The commands from the hosts can be any form that corresponds to one or more actual device commands, such as ATAPI commands. That is, the commands a host sends to the network directly attached storage based device over the network do not have to be actual device commands such as ATAPI commands, but can be something that can serve the purpose by executing one or more actual device commands depending on the actual device type of choice (such as for example, an ATAPI device or SCSI device) that is directly bridged to the network through the inventive bridge chip apparatus. The bridge chip apparatus therefore includes a capability for parsing the commands whatever they are and also includes means, such as the generic command wrapper, to speed up such parsing process.

The decoding and transforming enables the command execution core to accommodate new commands that were not identified to the command execution core hardware at the time the hardware was fabricated so that such new commands may be added at the later time without revising the hardware.

For alternative storage devices that are not ATA or ATAPI (ATA/ATAPI) storage devices, different top-level and lower-level command groups and subgroups may be provided in analogous manner. Note that ATA may be a command set for a device that has IDE interface. A typical ATA device is plain hard disk drive. ATAPI commands may generally be a super-set of ATA commands with additional ‘packet commands’ support. Typical ATAPI devices are optical disk drive (ODD), such as CD drive and DVD drive.

For example, although much of the description has focused attention on ATA/ATAPI storage devices and on their interfaces and command sets, it will be appreciated in light of the description provided here that the storage device and storage device interface of the bridge chip of the present invention can be of virtually any type now known or to be developed. By way of example, but not limitation, the device and interface may be any one of the following: ATA/ATAPI, SCSI, Universal Serial Bus or USB, IEEE 1394, or Serial ATAPI, or any combination, hybrid, improvement or enhancement of these types.

### Exemplary Embodiment Having Reduced Clock Tree

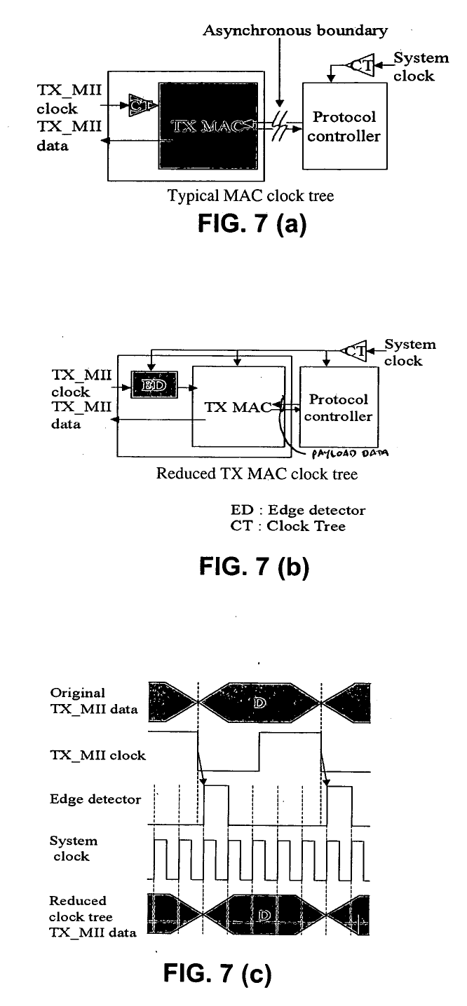

For a 1 Gb/s Ethernet MAC controller to support 10/100/1000 Mbps modes, it should support both Gigabit Media Independent Interface (GMII) and Media Independent Interface (MII). In conventional design, TX MAC controller uses two clock trees, one with 25 or 2.5 MHz clock sourced from the TX_MII pin of PHY-chip and the other with 125 MHz clock sourced from system clock as illustrated in FIG. 7A.

The two clock tree design is usually accompanied by the asynchronous communication overhead between MAC controller and protocol layer controller causing difficulties in back end process, synthesis of the chip. In the design of the present invention as illustrated in FIG. 7B, the reduced clock tree technique reduces the clock domain of TX MAC controller to the 125 MHz system clock only because edge detector of the TX_MII clock is used instead of the whole clock tree. The reduced clock technique of the present invention makes back end process simple and removes the asynchronous communication overhead.

FIG. 7B shows the timing diagram of the data transmitted when reduced clock tree technique is adopted. TX MAC controller always operates with 125 MHz system clock, and the controller changes its state only when edge detection signal is asserted by edge-detector at falling edge of the MII clock. Since the edge detection signal is asserted at 25 or 2.5 MHz period, TX MAC controller looks like operating with TX_MII clock.

It will be appreciated in light of the above description that one purpose of reduced “TX MAC clock tree” is to provide synchronization mechanism for the TX MAC and the protocol controller, where these two units are basically operating independent of others thus need or benefit from some way of synchronization. Instead of deploying separate clock to these two independent units, the inventive configuration uses the described reduced TX MAC clock tree mechanism to achieve an effective way of synchronization that uses or wastes a minimum amount of chip space and logic.

The TX MAC is a unit that actually generates the frame to be transmitted through the network controller, and the transmission of each frame has to be synched to the system clock (typically a 125 MHz clock if the network is gigabit Ethernet). The main idea of it is to ‘detect’ the edge of the actual moment of the frame data generated and to synchronize the transmission of the frame to the next system clock for actual frame transmission. The inventive reduced clock tree mechanism greatly reduces the complexity of clock system and synchronization issues of two independent units (the protocol controller and the TX MAC in the present case) where asynchronous border between them is involved. However, it will be appreciated that whenever there are two units that are governed by logically different clocks and the units are to transfer some data between them, there is a need for synchronization the activities of those two units for reliable data transfer between them. This aspect of the invention may therefore be practices separate and apart from the inventive bridge chip circuit and bridging or attachment method.

The foregoing descriptions of specific embodiments and best mode of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

We claim:

1. A bridge apparatus enabling direct access by at least one host to a raw storage device over a network, the bridge apparatus comprising:
a command execution unit for executing command packets received from the at least one host;
a memory controller coupled to the command execution unit;
a network interface including a network interface protocol layer handler for coupling the network with the command execution unit;
a device interface controller coupling the command execution unit with the raw storage device; and
wherein the bridge apparatus couples the raw storage device to the network directly such that the host accesses the raw storage device as if the raw storage device is local storage device even though the raw storage device is only available over the network.

2. A bridge apparatus as in claim 1, wherein a plurality of raw storage devices are coupled to the network for access by the host and each of the raw storage devices are coupled to the host via a separate bridge apparatus.

3. A bridge apparatus as in claim 1, wherein the data storage device comprises a rotating magnetic media hard disk drive storage device.

4. A bridge apparatus as in claim 1, wherein the data coming from or going to the raw data storage device go directly from the network through the bridge apparatus to the raw storage device.

5. A bridge apparatus as in claim 1, wherein combination of the bridge apparatus and the raw storage device provide a network directly accessible storage device.

6. A bridge apparatus as in claim 1, wherein the data on the raw storage device and the network directly accessible storage device is accessed without network file system.

7. A bridge apparatus as in claim 1, wherein the bridge apparatus comprises a bridge hardware logic circuit.

8. A bridge apparatus as in claim 1, wherein the storage device interface comprises an ATA/ATAPI storage device interface.

9. A bridge apparatus as in claim 1, wherein all of the data coming from or going to the storage device.

10. A bridge apparatus as in claim 1, wherein the network attached storage device comprises an interface bridge logic circuit coupled between the network and the raw storage device.

11. An apparatus as in claim 1, further comprising an error controller/handler for handling error conditions that arise during the process of disk read/write operations.

12. An apparatus as in claim 1, wherein the command execution unit further comprises:
a command execution core for parsing and execution of commands;
a read buffer for buffering the data to be sent to the host in response to the read command from the host;
a write buffer for buffering the data accompanying the write command to the networked storage device;
a command queue for queuing the commands sent to the networked storage device; and
a retransmission manager for managing the packet retransmission when the retransmission is required.

13. A bridge apparatus as in claim 1, wherein the memory controller further comprises a Direct Memory Access (DMA) controller unit.

14. An apparatus as in claim 1, wherein the network interface protocol layer handler of the network interface further comprises:
a frame encapsulator that encapsulates frame packets generated by the command execution unit by adding a header according to the NDAS protocol; and
a frame decapsulator that extracts predetermined information from frames received through the network controller and communicates to the command execution unit for further processing the commands.

15. An apparatus as in claim 14, wherein the interface protocol layer handler further comprising:
a sequence number manager generating a sequence number for each frame/packets sent to the network controller and associated with and coupled to the frame encapsulator;
an acknowledge number manager receiving a sequence number for each frame/packets received from the network controller and associated with and coupled to the frame decapsulator;
a comparator detecting a frame/packet loss by detecting the missing sequence number of the sequence of the packets received and generating a comparison result, the comparison result being communicated to the command execution unit; and
the protocol layer handler processing packets received from the network controller before transferring the packets to the command execution unit, and the packets from the command execution unit are transmitted after being processed by the protocol layer handler.

15. An apparatus as in claim 1, wherein the network protocol layer handler further includes means for managing multiple concurrent connections with the device by a plurality of hosts.

16. An apparatus as in claim 15, wherein the means for managing multiple concurrent connections includes command tagging means fro tagging commands, the tagging means including a tag manager that manipulates a tag field of the protocol packet.

17. An apparatus as in claim 16, wherein the protocol packet comprises an NDAS protocol format packet

18. An apparatus as in claim 17, wherein when protocol layer handler receives a connection establish request packet from a host that is requesting to establish a connection with the device for access to the device, the tag manager: (i) stores a host information identifying the requesting host.

19. An apparatus as in claim 18, wherein the tag number is acknowledged to the host as stamped in the tag field of a reply packet at the exchange to the connection establish request packet.

20. An apparatus as in claim 19, wherein after the connection between the requesting host and the device is created, the tag manager checks to determine if all the packets received originated from a proper host by comparing the stored host information of the packets to the connection information saved.

21. An apparatus as in claim 20, wherein the command tagging simplifies an address look-up procedure required for the connection management.

22. An apparatus as in claim 21, wherein a static random access memory (SRAM) is used for the address look-up hardware and the address look-up hardware uses only one comparator by exploiting the tagging procedure.

23. An apparatus as in claim 22, wherein the SRAM with a single comparator operates faster and occupies smaller chip area consuming less power that the content addressable memory (CAM) having multiple separate comparators.

24. An apparatus as in claim 23, wherein the connection manager coupled between the tag manager and a periodic timer and is triggered by the periodic timer initiating a connection clean-up procedure that clears up any connection that was disconnected abnormally during the process of data transmission between networked storage device and the host that the connection was disconnected abnormally.

25. An apparatus as in claim 1, wherein the device interface controller further comprises a storage device interface controller.

26. An apparatus as in claim 1, wherein the storage device interface controller comprises at least one of an: ATA/ATAPI storage device interface controller, an SCSI interface controller, a serial ATAPI interface controller, a universal serial bus (USB) interface controller, a Firewire interface controller, an IEEE 1394 interface controller, a Serial ATA or ATAPI interface controller, a parallel ATA or ATAPI interface controller, any serial interface controller, any parallel interface controller, and any combination of these interface controllers, and/or any other device interface controller appropriate to the type of storage device that is being interfaced.

27. An apparatus as in claim 1, wherein the storage device interface controller comprises an ATA/ATAPI storage device interface controller that processes ATA/ATAPI commands and data to and from an ATA/ATAPI connected storage device.

28. An apparatus as in claim 13, wherein the DMA controller handles direct memory access operation between the storage device and the bridge chip.

29. An apparatus as in claim 12, wherein the commands are stored in order by the protocol layer handler into the command queue.

30. An apparatus as in claim 29, wherein the command execution core parses the commands in the command queue and controls the write buffer and the device interface controller.

31. An apparatus as in claim 12, wherein the command execution core immediately writes data to the storage device when the storage device interface controller is available but, queues data to be written to the storage device in the write buffer before being stored to the storage device when the storage device interface controller is processing other commands and not available.

32. An apparatus as in claim 12, wherein the command execution unit controls the read buffer where data to be read may be temporarily stored for possible retransmission.

33. An apparatus as in claim 12, wherein the communication protocol includes a connection-oriented protocol wherein transmitted data are held for retransmission until the corresponding acknowledgements of the transmitted data are received by the networked storage device.

34. An apparatus as in claim 12, wherein the retransmission manager stores a predetermined amount of the most recently processed command instead of all the data transmitted, and when a data packet is lost retransmission manager puts the most recently processed command stored into the command queue again and rolls back the sequence number so that the command put back into the command queue will be processed again, so that the reprocessing of the command results in the retransmission of the reply data when the data sent are lost.

35. An apparatus as in claim 1, wherein the host may be any system or device requesting or having access to the storage device over the network.

36. An apparatus as in claim 1, wherein the host is selected from the set of hosts consisting of a computer, a communication device, any device having a processor or microprocessor and capable of storing or retrieving data or other information, a television TV set, a multimedia player or recorder, a media performance device, a digital audio player or recorder, a information appliance, a home appliance, an automobile, a transportation vehicle, a personal data assistant (PDA), and any combination thereof.

37. An apparatus as in claim 36, wherein the media performance device is selected from the set of media performance devices consisting of a video player device, an audio player device, an audio-video player device, a multi-media player device, an MP3 audio player device, an MPEG file player device, a CD or DVD player or recorder device, a movie player device, a television player device, a photograph display or player device, a printer device, a photographic printer device, any media content display or player device, any media content recorder device, and any combination of these.

38. An apparatus as in claim 36, wherein the device may be shared by a plurality of devices; and wherein the sharing may be any simultaneous, concurrent, multiplexed, multi-tasked, multi-threaded, or other shared access or the same or of different portions or data stored on the shared device.

39. An apparatus as in claim 36, wherein the storage device is selected from the set of storage devices consisting of solid state memory storage devices, compact flash card storage, SD memory devices, memory stick memory storage, digital or analog tape storage devices, optical storage devices, CD ROM storage devices, CD RAM storage devices, DVD storage devices, magnetic memory storage, rotating disk storage, magnetic rotating hard disk drive storage, a flash memory storage, a RAM memory storage device, a ROM memory storage device, and any combination of these.

40. An apparatus as in claim 1, wherein the device couples to a Gigabit-Ethernet network and the storage device comprises an ATA/ATAPI data storage device that is directly attached to the network and operates as a high performance network directly attached storage device.

41. An apparatus as in claim 14, wherein the Ethernet controller receives and transmits command packets and reply packets as specified in an NDAS communication protocol through Ethernet physical layer (Ethernet PHY) chip.

42. An apparatus as in claim 1, wherein the network is selected from the set of networks consisting of: a home network, the Internet network, a wireless network, a wired network, and any combination of these.

43. An apparatus as in claim 1, wherein the command execution core recognizes a generic command format that supports new commands added later time than the time of fabrication of the chip without revising the hardware chip.

44. An apparatus as in claim 1, wherein the command format is a format that comprises a command wrapper located in the command execution unit to identify how the command execution core is to operates by decoding the bit flags of the generic commands sent by the host un-necessitating the parsing of ATAPI command registers and packet command parameters to eliminate processing time and logic circuit bridge circuit chip space that would otherwise be required if full parsing process was required.

45. An apparatus as in claim 44, wherein the control registers include a data transfer mode (DMA or PIO) register, a command for read register, a command for write register, a command for packet command register, a command for LBA48(BigLBA) register, and a length for amount of transferred data register.

46. An apparatus as in claim 44, wherein the storage device comprises an ATA or ATAPI compatible storage device, and wherein the commands comprise ATA/ATAPI commands classified into one of two command groups: (i) a first group comprising disk commands for ATA devices, and (ii) a second group comprising packet commands for ATAPI devices.

47. An apparatus as in claim 44, wherein the first group and/or the second group are divided into command sub-groups, and wherein the subgroups may include any of a non-data sub-group, PIO data-in sub-group, PIO data-out sub-group, DMA read sub-group, and DMA write sub-group.

48. An apparatus as in claim 47, wherein the non-data command is used to set some parameters without data transfer.

49. An apparatus as in claim 47, wherein the PIO data-in and PIO data-out commands are used respectively to read and write data in PIO mode.

50. An apparatus as in claim 47, wherein the DMA read and DMA write commands are used respectively to read and write data in DMA mode, and the command execution core is operable either with or without parsing the value of control registers and packet command parameters.

51. An apparatus as in claim 37, wherein the command execution core operates without parsing the values of control registers and packet command parameters by (i) decode at least one bit flags of the command wrapper, and (ii) transforming the commands into the corresponding ATA/ATAPI commands

52. An apparatus as in claim 1, further comprising a reduced clock tree comprising:
a single clock tree receiving a system clock signal and generating a first synchronous clock output signal from the clock tree coupled to a protocol controller, a second synchronous clock output signal from the clock tree coupled to the TX MAC, and a third synchronous clock output signal from the clock tree coupled to an edge detector;
the edge detector also receiving a TX_MII clock signal and generating a signal that is coupled to the TX MAC; and
the TX MAC generating a TX_MII output data signal in response to the received signal from the edge detector, a first payload data signal from the protocol controller, and second clock signal from the clock tree.

53. An apparatus as in claim 52, wherein the clock tree and its first, second, and third output clock signals maintaining a synchronization between the protocol handler and the TX MAC and preventing asynchronization between them.

54. An apparatus as in claim 1, further comprising the raw storage device.

55. An apparatus as in claim 1, wherein the apparatus is formed as a least one semiconductor circuit chip.

56. A method for enabling direct access by at least one host to a raw storage device over a network, the method comprising:
executing command packets received from the at least one host;
coupling the network with the command execution unit using a interface protocol layer handler;
coupling the command execution unit with the raw storage device; and
the coupling of the raw storage device to the network being direct such that the host accesses the raw storage device as if the raw storage device is local storage device.
